(19) United States
(12) Patent Application Publication
(10) Pub. No.: US 2010/0068161 A1
(43) Pub. Date: Mar. 18, 2010

(54) TOPICAL COMPOSITION FOR THE PROTECTION AND/OR TREATMENT OF RADIATION RELATED SKIN DAMAGES

(75) Inventor: Fayek Todary Michael, Roxboro (CA)

Correspondence Address: BENOIT & COTE, s.e.n.c., 1001, DE MAISONNEUVE BOULEVARD WEST, SUITE 210, MONTREAL, QC, H3A 3C8, CA

(73) Assignee: Fayek, Roxboro (CA)

(21) Appl. No.: 12/559,954

(22) Filed: Sep. 15, 2009

(30) Foreign Application Priority Data
Sep. 16, 2008 (CA) 2639525

(51) Int. Cl. A61Q 17/04

(52) U.S. Cl. 424/59

(57) ABSTRACT

There is provided a topical composition for the protection and/or treatment of radiation related skin damages comprising from 18.4% to 68% by volume of active principles comprising anti-oxidants, moisturizers, humectants, emollients, anti-inflammatory agents, healing promoting agents and dermal circulation enhancers in from 81.6% to 32% by volume of a pharmaceutically acceptable carrier.

### BACKGROUND

The subject matter disclosed generally relates to a topical composition for the protection and/or treatment of radiation related skin damages comprising from 18.4% to 68% by volume of active principles comprising anti-oxidants, moisturizers, humectants, emollients, anti-inflammatory agents, healing promoting agents and dermal circulation enhancers in from 81.6% to 32% by volume of a pharmaceutically acceptable carrier.

It is well known that a high percentage of cancer patients receive Radiotherapy after Chemotherapy and/or surgery. This fact became more common among women who suffer breast cancer. Nowadays also, many people are subjected to laser rays for treatment or cosmetic purposes.

In addition, another group of young and mid-age population, mainly women, who are voluntarily subjecting their skin to UV rays whether naturally exposing themselves to direct sunlight or artificially via tanning process are subject to skin damage and adverse effects of such types of radiation.

### Radiotherapy

During treatment with Radiotherapy, radiation must pass through the patient's skin. Patient will notice some skin changes in the area exposed to radiation. Patient's skin may become red, warm, dehydrated and sensitive as if she/he had sunburn. It may also become darker and appear tanned. It may peel or become moist and tender. If patient's skin is not protected by a product to prepare her/his skin to receive Radiotherapy and continue its use during and after completion of radiation sessions, then the result will be an obvious damage to patient's skin. If these adverse reactions continue during the four to five weeks of radiation, i.e. during all sessions, then patient will be suffering serious damage to her/his skin that may lead to obvious scar.

### Ultraviolet Light

Prolonged exposure to ultraviolet light (UVA or UVB) from sunlight accounts for a high percentage of the symptoms of premature skin aging. Many skin changes that were commonly believed to be due to aging, are actually a result of prolonged exposure to UV radiations which are divided into three types based on the wavelength. These different types of UV radiations are detailed in Table 1.

TABLE 1

| Type of UV | Wavelength | Impact on skin |
|---|---|---|
| UVC | 100 to 290 nm | does not affect the skin |
| UVB | 290 to 320 nm | affects the outer layer thus |
| | | responsible for sunburn. |
| UVA | 320 to 400 nm | penetrates deeply causing |
| | | major skin damage. |

### Laser Rays

For most people, the laser treatment produces an irritating or painful feeling similar to series of pricks with a warm needle. The treated area will probably swell, turn red, or become slightly discolored for one to three days. With proper treatment, blistering should not occur, therefore permanent scarring or discoloration will be very rare.

Therefore, it would be highly desirable to be provided with a novel topical composition for the protection and/or treatment of radiation related skin damages in order to improve patient's skin condition when submitted to radiation.

### SUMMARY

In a first embodiment, there is disclosed a topical composition for the protection and/or treatment of radiation related skin damages comprising from 18.4% to 68% by volume of active principles comprising anti-oxidants, moisturizers, humectants, emollients, anti-inflammatory agents, healing promoting agents and dermal circulation enhancers in from 81.6% to 32% by volume of a pharmaceutically acceptable carrier.

The active principles of the topical composition may be present in a proportion of:

a) from 0.5% to 3.55% by volume of anti-oxidants;

b) from 3.0% to 14.3% by volume of moisturizers;

c) from 3.0% to 11.9% by volume of humectants;

d) from 6.0% to 19.0% by volume of emollients;

e) from 4.0% to 14.2% by volume of anti-inflammatory agents;

f) from 2.0% to 11.9% by volume of healing promoting agents; and

g) from 2.0% to 6.0% by volume of dermal circulation enhancers.

The anti-oxidants may be selected from the group consisting of glutathion, vitamin C, alpha lipoic acid, beta-carotene, alpha-tocopherols, lutein and combinations thereof.

The moisturizers may be selected from the group consisting of stearic acid, myrestyl alcohol, white petrolatum, glycerin, lanolin, hydrogenated polydecene, cetearyl alcohol and combinations thereof.

The humectants may be selected from the group consisting of glyceryl triacetate, sorbitol, quillaia, urea, glycerin, lactic acid, aloe vera, propylene glycol and combinations thereof.

The emollients may be selected from the group consisting of butyrospermum parkii oil, licithin, olive oil, glyceryl stearate, stearyl alcohol, cetyl alcohol, behenyl alcohol, limnanthes alba seed oil, palmitic acid and combinations thereof.

The anti-inflammatory agents may be selected from the group consisting of glyccyrrhiza glabra, provitamin-b5, curcuma longa, lauriminodipropionate sodium, zinc oxide and combinations thereof.

The healing promoting agents may be selected from the group consisting of collagen hydrolysate, aldioxa, hyaluronic acid, elastin, ascorbyl palmitate and combinations thereof.

The dermal circulation enhancers may be selected from the group consisting of gingko biloba, ginger, ethyl alcohol, arginine, cayenne and combinations thereof.

The topical composition may further comprise at least one of:

h) vitamins;

i) minerals;

j) emulsifiers; and

k) preservatives.

The vitamins, minerals, emulsifiers and preservatives may be present in the composition in a proportion of:

h) from 0.02% to 6.0% by volume of vitamins;

i) from 0.17% to 7.14% by volume of minerals;

j) from 0.1% to 6.8% by volume of emulsifiers; and

k) from 0.2% to 2.4% by volume of preservatives.

The vitamins may be selected from the group consisting of vitamin A, biotin, vitamin E, vitamin C, vitamin D and combinations thereof.

The minerals may be selected from the group consisting of zinc, sodium, potassium, selinium, manganese, copper, calcium and combinations thereof.

The emulsifiers may be selected from the group consisting of sodium lauryl sulfate, trideceth-6, pluronic acid F-127, polyacrylate sodium, triethanolamin, hydroxyethylcetearamidopropyl dimonium chloride and combinations thereof.

The preservatives may be selected from the group consisting of benzoic acid, caprylyl glycol, Diazolidinyl urea, Phenoxyethanol, Dehydroacetic acid, Iodopropynylbutylcarbamate, Sorbic acid, Isopropyl-paraben, Isobutyl-paraben, Butyl-paraben.

The topical composition may further comprise at least one of:

l) thickening agents; and

m) keratolytic agents.

The thickening agents and keratolytic agents may be present in the composition in a proportion of:

l) from 0.1% to 2.4% by volume of thickening agents; and

m) from 1.0% to 2.4% by volume of keratolytic agents.

The thickening agents may be selected from the group consisting of carboxy methylcellulose, carbomer, carrageenan, gum acacia, sterculia gum, xanthan gum and combinations thereof.

The keratolytic agents may be selected from the group consisting of salicylic acid, alcloxa, allantoin, glycolic acid and combinations thereof.

The topical composition may further comprise perfumes in a proportion of from 0.01% to 2.4% by volume.

The perfumes may be selected from the group consisting of essential oils, aroma compounds, fixatives, solvents, water-soluble perfumes and combinations thereof.

The topical composition may be formulated as a cream.

The topical composition may be formulated as a liquid cream.

The topical composition may be formulated as a lotion.

The topical composition may be formulated as a gel.

The pharmaceutically acceptable carrier may comprise at least two ingredients selected from the group consisting of deionized water, ethyl alcohol, witch hazel extract, myrestyl alcohol, propylene glycol and combinations thereof.

In accordance with one embodiment, there is disclosed the use of a therapeutically effective amount of the topical composition for the prevention and/or treatment of radiation related skin damages in a subject.

The use of the topical composition may comprise topically contacting a skin area of a patient with a therapeutically effective amount of the topical composition.

The radiation may be radiotherapy.

The radiation may be laser.

The radiation may be UV Rays.

The radiation related skin damages may comprise burns, ulcers, irritation, pain and/or itching.

Topically contacting the skin area with the composition may be effected before, during and/or after radiation.

The gel or lotion formulation of the composition may be applied during radiotherapy. The composition may be applied three times daily following radiotherapy sessions, and the composition may be removed just before the next radiotherapy session.

The cream or liquid cream formulation of the composition may be applied before radiotherapy. The composition may be applied during one to two weeks before radiotherapy, two to three times daily.

The cream or liquid formulation of the composition may be applied after radiotherapy. The composition may be applied during two weeks after radiotherapy, three times daily.

The cream or liquid formulation of the composition may be applied until skin condition is restored.

Topically contacting the problem area with the composition may be done after the radiation in cases of laser and UV rays exposition.

The cream, liquid cream, gel or lotion formulation may be applied after laser of UV rays exposition, for three to seven days.

The cream, liquid cream, gel or lotion formulation my also be applied until skin condition is restored, three times daily.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### DETAILED DESCRIPTION OF THE PREFERRED EMBODIMENTS

In embodiments there are disclosed a topical composition for the protection and/or treatment of radiation related skin damages comprising from 18.4% to 68% by volume of active principles comprising anti-oxidants, moisturizers, humectants, emollients, anti-inflammatory agents, healing promoting agents and dermal circulation enhancers in from 81.6% to 32% by volume of a pharmaceutically acceptable carrier.

The focus here is the composition and the method of application to patient's skin. This formula includes all required ingredients that prevent and restore skin damage which results mainly from Radiotherapy that is given to Cancer patients. It also showed the same success in prevention and restoration of skin damage, which takes place due to laser or UV rays that are used for cosmetic purposes.

This product (cream, liquid cream, gel or lotion) reduces damage of treated skin to a minimum level that allows rapid healing and restoration without scaring. Comparisons were made between people who were using the product and many other who were not using the same. Results showed dramatic difference in skin protection from adverse effects for the users of the present composition. Adverse effects were reduced to 25% of the damage seen on the skin of other patients who did not use the composition. This dramatic reduction of skin damage allows rapid healing without scars.

### Materials and Methods

### Radiotherapy

For best results with Radiotherapy, patient should begin using the cream or liquid cream form of the composition one to two weeks before starting Radiotherapy. Patient will apply the cream 2-3 times daily to nourish and provide enough hydration to skin area that will be radiated. Once starting radiation sessions patient will stop the cream and apply the gel or lotion form of the composition during all sessions. The gel or lotion will be applied three times daily. The first application should be immediately after radiation session (before patient puts back her/his clothes). When patient gets home she/he will apply twice again during the day but wash off the composition just before the next session. Improvement is linked to number of daily applications. Once radiation sessions are completed, patient will restart using the cream or liquid cream form again three times daily for two weeks until normal skin is restored.

### Laser, Tanning Sessions and Sunburn

Apply any form of the composition (cream, liquid cream, gel or lotion form) immediately after the event and continue to apply 3 times daily to affected area for 3 to 7 days until normal skin is restored. Improvement is linked to number of daily applications.

### Formulation and Active Principles of Composition

The composition comprises certain active principles selected from a group of 15 possible components. For example, a formulation of the composition may contain from 18.4% to 68% of the groups of active principles of Table 2 in suspension in from 81.6% to 32% by volume of a pharmaceutically acceptable carrier to achieve the desired therapeutic effect of the composition:

TABLE 2

| | Active Principle |
|---|---|
| 1. | Anti-oxidants |
| 2. | Moisturizers |
| 3. | Keratolytic agents |
| 4. | Humactants |
| 5. | Emolients |
| 6. | Anti-Inflammatory |
| 7. | Healing Promoters |
| 8. | Dermal Circulation Enhancers |
| 9. | Vitamins |
| 10. | Minerals |
| 11. | Thickening Agents |
| 12. | Emulsifiers |
| 13. | Preservatives |
| 14. | Vehicles (carriers) |
| 15. | Perfumes |

These 15 possible active principles are found in the proportions listed in Table 3 when all present in the composition.

TABLE 3

| | | | |
|---|---|---|---|
| | | Minimum | Maximum |
| Serial # | Ingredient | Percentage | percentage |

First Priority Items:
Anti-oxidants: (the formula contains one or more
antioxidants with the total percentage indicated below)

| | | | |
|---|---|---|---|
| 1. | Glutathion | 0.2 | 3.0 |
| 2. | Vitamin C | | |
| 3. | Alpha Lipoic acid | | |
| 4. | Beta-Carotene | | |
| 5. | Alpha-Tocopherols | | |
| 6. | Lutein | | |

Moisturizers: (the formula contains one or more
moisturizer with the total percentage indicated below)

| | | | |
|---|---|---|---|
| 7. | Stearic acid | 3.0 | 12.0 |
| 8. | Myrestyl Alcohol | | |
| 9. | White Petrolatum | | |
| 10. | Lanolin | | |
| 11. | Hydrogenated polydecene | | |
| 12. | Cetearyl alcohol | | |
| 13. | Glycerin | | |

Humactants: (the formula contains one or more
Humectants with the total percentage indicated below)

| | | | |
|---|---|---|---|
| 14. | Glyceryl triacetate | 3.0 | 10.0 |
| 15. | Sorbitol | | |
| 16. | Quillaia | | |
| 17. | Urea | | |
| 18. | Glycerin | | |
| 19. | Lactic acid | | |
| 20. | Aloe vera | | |
| 21. | Propylene glycol | | |

Emolients: (the formula contains one or more
emolients with the total percentage indicated below)

| | | | |
|---|---|---|---|
| 22. | Butyrospermum parkii oil | 6.0 | 16.0 |
| 23. | Licithin | | |
| 24. | Olive oil | | |
| 25. | Glyceryl stearate | | |
| 26. | Stearyl alcohol | | |
| 27. | Cetyl alcohol | | |
| 28. | Benhenyl alcohol | | |
| 29. | Limnanthes alba seed oil | | |
| 30. | Palmitic acid | | |

Anti-inflammatory: (the formula contains one or more Anti-
inflammatory ingredients with the total % indicated below)

| | | | |
|---|---|---|---|
| 31. | Glyccyrrhiza glabra (Cortisone | 4.0 | 12.0 |
| | like structure) | | |
| 32. | Provitamin B5 | | |
| 33. | Curcuma longa | | |
| 34 | Lauriminodipropionate sodium | | |
| 35. | Zinc Oxide | | |

Healing Promoters: (the formula contains one or more Healing
promoters with the total percentage indicated below).

| | | | |
|---|---|---|---|
| 36. | Collagen Hydrolysate | 2.0 | 10.0 |
| 37. | Aldioxa | | |
| 38. | Hyaluronic acid | | |
| 39. | Elastin | | |
| 40. | Ascorbyl Palmitate | | |

Dermal Circulation Enhancers: (the formula contains one or more
dermal circulation enhancers with total % indicated below).

| | | | |
|---|---|---|---|
| 41. | Gingko Biloba | 0.2 | 5.0 |
| 42. | Ginger | | |
| 43. | Ethyl alcohol | | |
| 44. | Arginine | | |
| 45. | Cayenne | | |

Second Priority Items:
Vitamins: (the formula contains one or more
vitamins with the total percentage indicated below).

| | | | |
|---|---|---|---|
| 46. | Vitamin A | 0.02 | 5.0 |
| 47. | Biotin | | |
| 48. | Vitamin E | | |
| 49. | Vitamin C | | |
| 50. | Vitamin D | | |

Minerals: (the formula contains one or more Mineral
salts with the total percentage indicated below).

| | | | |
|---|---|---|---|
| 51. | Zinc | 0.17 | 6.0 |
| 52. | Sodium | | |
| 53. | Potasium | | |
| 54. | Selinium | | |
| 55. | Manganese | | |
| 56. | Copper | | |
| 57. | Calcium | | |

Emulsifiers: (the formula contains one or more
Emulsifiers with the total percentage indicated below).

| | | | |
|---|---|---|---|
| 58. | Sod. Lauryl Sulfate | 0.10 | 5.0 |
| 59. | Trideceth-6 | | |
| 60. | Pluronic acid F-127 | | |
| 61. | Polyacrylate sodium | | |
| 62. | Triethanolamin | | |
| 63. | Hydroxyethylcetearamidopropyl | | |
| | dimonium chloride | | |

Preservatives: (the formula contains two or more
preservatives with the total percentage indicated below).

| | | | |
|---|---|---|---|
| 64. | Benzoic acid | 0.2 | 2.0 |
| 65. | Caprylyl glycol | | |
| 66. | Diazolidinyl urea | | |
| 67. | Phenoxyethanol | | |
| 68. | Dehydroacetic acid | | |
| 69. | Iodopropynylbutyl-carbamate | | |
| 70. | Sorbic acid | | |
| 71. | Isopropyl-paraben | | |
| 72. | Isobutyl-paraben | | |
| 73. | Butyl-paraben | | |

Vehicles (I.E. Solvant, Alchol, Demulcent and water):
(the formula contains two or more vehicles with the
total percentage indicated below).

| | | | |
|---|---|---|---|
| 74. | Deionized Water | 80.0 | 8.0 |
| 75. | Ethyl alcohol | | |
| 76. | Witch Hazel extract | | |
| 77. | Myrestyl alcohol | | |
| 78. | Propylene glycol | | |

Third Priority Items:
Thickening agents: (the formula contains one or more Thickening
agents with the total percentage indicated below).

| | | | |
|---|---|---|---|
| 79. | Carboxy Methyl Cellulose | 0.10 | 2.0 |
| 80. | Carbomer | | |
| 81. | Carrageenan | | |
| 82. | Gum Acacia | | |
| 83. | Sterculia Gum | | |
| 84. | Xanthan Gum | | |

Keratolytic agents: (the formula contains one or more Keratolytic
agents with the total percentage indicated below)

| | | | |
|---|---|---|---|
| 85. | Salicilyc acid | 1.0 | 2.0 |
| 86. | Alcloxa | | |
| 87. | Allantoin | | |
| 88. | Glycolic acid | | |

Fourth Priority Items:
Perfumes: (the formula contains one or more perfume
with the total percentage indicated below).

| | | | |
|---|---|---|---|
| 89. | Optional Choice (to mask odor) | 0.01 | 2.0 |
| 90. | Optional Choice (to mask odor) | | |

| | | |
|---|---|---|
| Total Percentage | 100% | 100% |

Various adverse effects are caused by the application of radiation on a subject's skin. In fact, theses effects include an impact on the outer layer and on the underlying structure of the skin, as well as on its biological functions.

Changes that would Take Place in Skin Structure are:
1. Dehydration leading to wrinkles
2. Decrease of synthesis of collagen, elastin and the connective tissues of the structure of skin that leads to more wrinkles and change in the natural appearance of the skin.
3. Destruction of the activities of different anti-oxidation enzymes and other biological cell functions.
4. Discoloration and pigmentation of skin.
5. Skin becomes inflamed and tender.
6. Depending on the sensitivity of skin, it may become moist and peel off.

As a result, the affected skin becomes burdened with dysfunctions and starts to struggle for healing process that will become more difficult in the absence of many biological ingredients that support the biological enzymes activities and help restore the original healthy skin structure.

On this basis, the composition has been formulated for skin protection and treatment in view of radiation related skin damages. The various active principles comprised in the composition each have their mechanism of action.

### The Anti-Oxidants Group:

To minimize oxidation process that leads to early termination of cells' life.

### Moisturizers Group:

Its function immediately after radiation is to restore hydration lost during the radiation process.

### Humectants Group:

This group supports the moisturizing process by absorbing the atmospheric moisture into skin to replace the moisture loss by evaporation

### Keratolytic Agents:

This group assists in the process of shedding out the outer dead layer of the skin allowing the formation of new healthy cells.

### Emollients:

They soften the rough skin texture and form outer layer that acts as a barrier and sealer to maintain skin hydration and further protect it from environmental effects during the interval between radiation sessions.

### Anti-Inflammatory Group:

Skin inflammation induced by effect of radiation on the skin causing the effect of the reactive oxygen species and free radicals to be reduced by the effect of anti-inflammatory group together with the effect of antioxidants.

### Healing Promoters:

This group contributes in the support and building of the connective tissues of the skin thus improving the healing process.

### Dermal Circulation Enhancers:

By improving blood circulation into the affected skin area will enhance the process of natural healing through delivering nutrients carried by the blood stream to the affected area. This will contribute to healthy restoration of skin.

### Vitamins:

Vitamins are very important factors for skin cells' biological functions. Some specific vitamins stimulate collagen synthesis therefore rebuilding the skin structure and restoring its original thickness

### Minerals:

They are an important part of the activities of the biological enzyme systems. Their presence stimulates the activities of enzyme defense against oxidative cell damage.

### Thickening Agents:

Enhance the consistency of the composition to be more manageable by user while applying to skin, to form a stable layer that gives its required therapeutic effects.

### Emulsifiers:

This group is important for the stability of the composition. Also, it plays an important role in the delivery of active ingredients to the deeper skin tissues. While patient is lightly rubbing the composition to his/her skin in a circular motion, a mild disruption of the outer skin layer will take place. The outer layer consists of dead cells (stratum corneum) that prevents the active ingredients from reaching the deeper structure of the skin. Mild disruption of stratum corneum allows access of the active ingredients to the skin structure. This will result in an improved restoration and healing of the affected skin area.

### Preservatives:

Keep the integrity of the composition for long time and protect skin from the attacks of atmospheric bacteria.

### Vehicle (Carrier):

This group gathers all ingredients in a well balanced media (carrier) that have suitable and stable PH to secure the maximum effect of each ingredient. In addition, it gives demulcent and cooling effect to the radiated skin.

### Perfumes:

Their purpose is just to mask the odors of different ingredients and provide a pleasant odor to the composition.

### Alternative Embodiments

### Example I

Some experts of Radiotherapy prefer that patient do not use the cream form of the composition during Radiotherapy because of the fear that patient would leave the cream on her/his skin during radiation session, which may cause the oils in the cream to heat up by the aggressive radiation and cause more damage to the patient's skin. In these cases, an aqueous base product is used during the radiation sessions while the cream form is used in the preparation stage and after completing the Radiotherapy. Different forms of the composition are presented in order to allow more flexibility. Because of the active ingredients, the composition forms herein presented are effective at any stage, but the difference in the design of the products is made for the safety of the patient.

### Example II

The results of an experimentation on post radiation signs and symptoms of the skin of a group of patients using the present composition in comparison to a group of patients using no products at all are presented in Table 4 below:

TABLE 4

| | Signs and | | Group of patients |
|---|---|---|---|
| | symptoms | Group of patients | using the present |
| | of skin | using no product | composition |
| 1 | Rash | Moderate to severe | Mild |
| 2 | Blisters | Moderate to severe | None |
| 3 | Erythema | Moderate to severe | Mild |
| 4 | Exudation | Moderate to severe | None |
| 5 | Excoriation | Moderate to severe | None |
| 6 | Dryness | Moderate to severe | Mild |
| 7 | Lichenification | Moderate to severe | None |
| 8 | Cracking | Moderate to severe | None |
| 9 | Pigmentation | Moderate to severe | Mild |
| Notes | | Pigmentation for patients | Pigmentation for |
| | | using no product | product users |
| | | continued until last follow | disappeared after |
| | | up with them | 2-3 months |

Legend:
Rash: an eruption on the body typically with little or no elevation above the surface.
Blisters: a fluid-filled elevation of the epidermis.
Erythema: abnormal redness of the skin due to capillary congestion (as in inflammation)
Exudation: the process of exuding
Dryness: lack of hydration or water.
Cracking: to cut or break a fragment.
Pigmentation: coloration with deposition of pigment (an excessive deposition of bodily pigment).
Licheification: the process by which skin becomes hardened and leathery or lichenoid usually as a result of chronic irritation; also, a patch of skin so modified.

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

1. A topical composition for the protection and/or treatment of radiation related skin damages, said topical composition comprising from 18.4% to 68% by volume of active principles comprising:
a) anti-oxidants;
b) moisturizers;
c) humectants;
d) emollients;
e) anti-inflammatory agents;
f) healing promoting agents; and
g) dermal circulation enhancers
in from 81.6% to 32% by volume of a pharmaceutically acceptable carrier.

2. The topical composition according to claim 1, wherein said active principles are present in a proportion of:
a) from 0.5% to 3.55% by volume of anti-oxidants;
b) from 3.0% to 14.3% by volume of moisturizers;
c) from 3.0% to 11.9% by volume of humectants;
d) from 6.0% to 19.0% by volume of emollients;
e) from 4.0% to 14.2% by volume of anti-inflammatory agents;
f) from 2.0% to 11.9% by volume of healing promoting agents; and
g) from 2.0% to 6.0% by volume of dermal circulation enhancers.

3. The topical composition according to claim 1, wherein said anti-oxidants are selected from the group consisting of glutathion, vitamin C, alpha lipoic acid, beta-carotene, alpha-tocopherols, lutein and combinations thereof.

4. The topical composition according to claim 1, wherein said moisturizers are selected from the group consisting of stearic acid, myrestyl alcohol, white petrolatum, glycerin, lanolin, hydrogenated polydecene, cetearyl alcohol and combinations thereof.

5. The topical composition according to claim 1, wherein said humectants are selected from the group consisting of glyceryl triacetate, sorbitol, quillaia, urea, glycerin, lactic acid, aloe vera, propylene glycol and combinations thereof.

6. The topical composition according to claim 1, wherein said emollients are selected from the group consisting of butyrospermum parkii oil, licithin, olive oil, glyceryl stearate, stearyl alcohol, cetyl alcohol, behenyl alcohol, limnanthes alba seed oil, palmitic acid and combinations thereof.

7. The topical composition according to claim 1, wherein said anti-inflammatory agents are selected from the group consisting of glyccyrrhiza glabra, provitamin-b5, curcuma longa, lauriminodipropionate sodium, zinc oxide and combinations thereof.

8. The topical composition according to claim 1, wherein said healing promoting agents are selected from the group consisting of collagen hydrolysate, aldioxa, hyaluronic acid, elastin, ascorbyl palmitate and combinations thereof.

9. The topical composition according to claim 1, wherein said dermal circulation enhancers are selected from the group consisting of gingko biloba, ginger, ethyl alcohol, arginine, cayenne and combinations thereof.

10. The topical composition according to claim 1, which further comprises at least one of:
h) vitamins;
i) minerals;
j) emulsifiers; and
k) preservatives.

11. The topical composition according to claim 10, wherein said active principles are present in a proportion of:
h) from 0.02% to 6.0% by volume of vitamins;
i) from 0.17% to 7.14% by volume of minerals;
j) from 0.1% to 6.8% by volume of emulsifiers; and
k) from 0.2% to 2.4% by volume of preservatives.

12. The topical composition according to claim 10, wherein said vitamins are selected from the group consisting of vitamin A, biotin, vitamin E, vitamin C, vitamin D and combinations thereof.

13. The topical composition according to claim 10, wherein said minerals are selected from the group consisting of zinc, sodium, potassium, selinium, manganese, copper, calcium and combinations thereof.

14. The topical composition according to claim 10, wherein said emulsifiers are selected from the group consisting of sodium lauryl sulfate, trideceth-6, pluronic acid F-127, polyacrylate sodium, triethanolamin, hydroxyethylcetearamidopropyl dimonium chloride and combinations thereof.

15. The topical composition according to claim 9, wherein said preservatives are selected from the group consisting of benzoic acid, caprylyl glycol, Diazolidinyl urea, Phenoxyethanol, Dehydroacetic acid, Iodopropynylbutylcarbamate, Sorbic acid, Isopropyl-paraben, Isobutyl-paraben, Butyl-paraben.

16. The topical composition according to claim 1, which further comprise at least one of:
l) thickening agents; and
m) keratolytic agents.

17. The topical composition according to claim 16, wherein said active principles are present in a proportion of:
l) from 0.1% to 2.4% by volume of thickening agents; and
m) from 1.0% to 2.4% by volume of keratolytic agents.

18. The topical composition according to claim 16, wherein said thickening agents are selected from the group consisting of carboxy methyl cellulose, carbomer, carrageenan, gum acacia, sterculia gum, xanthan gum and combinations thereof.

19. The topical composition according to claim 16, wherein said keratolytic agents are selected from the group consisting of salicylic acid, alcloxa, allantoin, glycolic acid and combinations thereof.

20. The topical composition according to claim 1, which further comprises perfumes in a proportion of from 0.01% to 2.4% by volume.

21. The topical composition according to claim 20, wherein said perfumes are selected from the group consisting of essential oils, aroma compounds, fixatives, solvents, water-soluble compounds and combinations thereof.

22. The topical composition of claim 1, which is formulated as a cream.

23. The topical composition of claim 1, which is formulated as a liquid cream.

24. The topical composition of claim 1, which is formulated as a lotion.

25. The topical composition of claim 1, which is formulated as a gel.

26. The topical composition according to claim 1, wherein said pharmaceutically acceptable carrier comprises at least two ingredients selected from the group consisting of deionized water, ethyl alcohol, witch hazel extract, myrestyl alcohol, propylene glycol and combinations thereof.
